(19) United States
(12) Patent Application Publication
(10) Pub. No.: US 2018/0320396 A1
(43) Pub. Date: Nov. 8, 2018

(54) DECORATIVE CABINET ENCLOSURE AND METHOD FOR PRODUCTION THEREOF

(71) Applicant: Highwood USA, LLC, Hometown, PA (US)

(72) Inventor: John Quarmley, Kutztown, PA (US)

(73) Assignee: Highwood USA, LLC, Hometown, PA (US)

(21) Appl. No.: 15/587,446

(22) Filed: May 5, 2017

(51) Int. Cl. E04H 4/14; A47B 81/00; A47B 96/20; B29C 51/26

(52) U.S. Cl. CPC E04H 4/14; A47B 81/00; B29L 2031/722; B29C 51/264; B29C 51/266; A47B 96/205

(57) ABSTRACT

A panelized system and method providing an infinite number of authentic, aesthetic, and tactile options for producing decorative cabinet enclosures for hot tubs is based on the use of high-resolution digital printing on plastic sheets, post-forming said sheets, and molding structural elements on such sheets for assembly of enclosures for hot tubs.

### CROSS REFERENCE TO RELATED APPLICATION

This application claims the benefit of U.S. Provisional Application No. 62/443,188 filed on Jan. 6, 2017.

### FIELD OF THE INVENTION

The present invention relates in general to enclosures for hot tubs and a new method for the production of such enclosures.

### BACKGROUND

From their inception, hot tubs employed natural wood, typically redwood and cedar, as the enclosure of the appliance. Natural wood suffers from discoloration and rot, due to exposure to the sun, water treatment chemicals used in the spa water, insect infestation, dry rot, and such other degradation as mildew. To provide a degree of longevity, manufacturers of hot tubs began to adopt synthetic wood products in 1998 to 2002. These cabinets provide the look of natural wood without suffering the degradation from the elements. Both the wood and synthetic wood enclosures must be built up from individual staves, typically tongue and groove boards, and fitted to each model of hot tub, requiring the manufacturer to maintain a complete woodshop and skilled woodworkers.

Driven by styling trends in both indoor and outdoor products, consumers desire a variety of aesthetics in appliances, furniture, decking, and related outdoor accessories. Current technologies for hot tub enclosures are limited to wood looks and a very limited array of stone veneers. The wood-look products are economically viable, while limited in design potential (color range is limited, style is limited to wood aesthetics). The stone-look products are prohibitively expensive, while not providing an authentic appearance (these products look and feel “plastic”). Further, currently available enclosures require the manufacturer to assemble the individual components to fabricate a finished hot tub cabinet.

The present invention provides a panelized system with infinite, authentic aesthetic and tactile options to the hot tub manufacturer. This system, and the method of producing the panels, is novel over the prior art that does not teach or suggest the system or the method of production. For example, U.S. Pat. No. 7,081,291 to Courtoy et al, while describing a process for the mechanical embossing of wear layers for floor coverings, has no technology based on digital printing and thermoforming as described herein. Neither does UK Patent 2,345,469 to Harris for production of facing panels for interiors of doors teach the more sophisticated method, much less the system, invented by Applicant.

### SUMMARY OF THE INVENTION

According to the present invention, three disparate technologies are brought together to create a wholly new approach to designing and fabricating hot tub cabinets. The first element comprises high-resolution, high-speed digital printing on large plastic sheets (up to 60″×120″). The digital printing technology is capable of generating any image, whether created by an artist, photographed, or direct digital scans of materials. The printing provides very high resolution (up to 1200×1200 dpi) and infinite color sets. There is no limit on the aesthetics from abstract to authentic natural looks. The second element comprises post-forming of the printed sheets to impart tactile dimension to the printed sheet. Using a thermoforming method, the sheets are heated and molded against a pattern, which is transferred to the sheet. The pattern can be any design, from subtle texture only to dramatic relief in the plane of the sheet. Additionally, the sheet edges can be formed to integrate with the hot tub frame, liner, and trim, providing additional utility during the installation of the cabinet. The pattern may simulate brushed metal, weathered wood, cobblestone, leather, yarn/fabric, or abstract designs—any pattern desired. The final element of the invention comprises molding structural elements into the sheet to provide a ready-to-install cabinet section, with the result that no fabrication by the hot tub manufacturer is required. The structural elements are angles, hat sections, clips, channels, and similar reinforcing sections that impart stiffness and attachment points to the panel.

### BRIEF DESCRIPTION OF THE DRAWINGS

The invention will become more readily apparent from the following description of preferred embodiments thereof shown, by way of example only, in the accompanying drawings wherein:

FIG. 1 is a frontal view of the article of manufacture as in one aspect of this invention.

FIG. 2 is a multi-layer view of one aspect of the article of manufacture of this invention.

FIG. 3 is a perspective view of this article of manufacture according to one aspect of the invention.

FIG. 4 is a perspective view of a cutaway section of the article of manufacture according to one aspect of the invention.

### DETAILED DESCRIPTION OF THE INVENTION

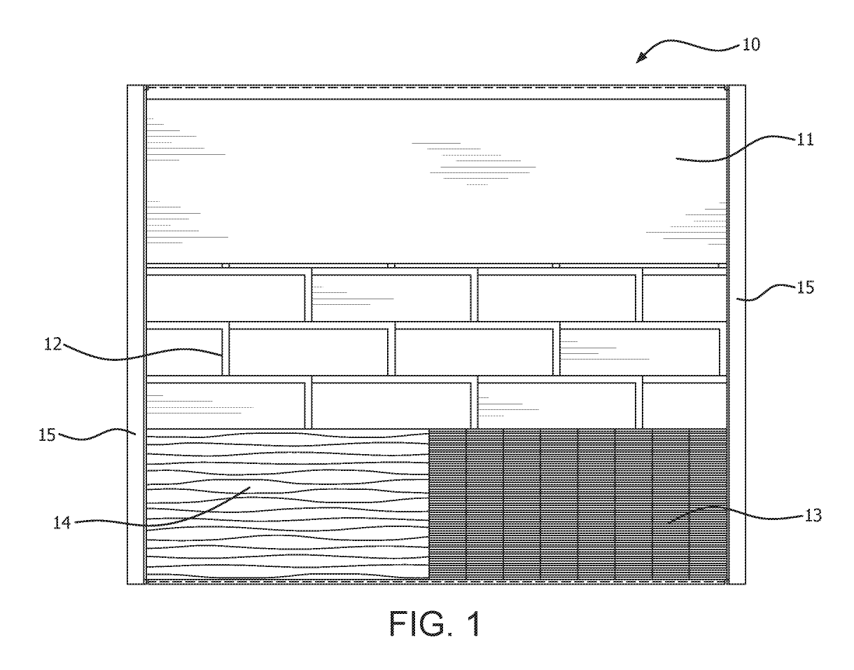

FIG. 1 illustrates an exemplary version of the article of manufacture that is covered by this application. The article of manufacture 10 is a panel comprised of separable (tactilely distinguishable) sections 11, 12, 13, and 14. It should be noted that separable sections 11, 12, 13 and 14 as depicted in FIG. 1 are merely representative of different patterns having tactile dimension for sections of said panel 10 being, respectively, a flat finish in section 11, a brick or stone finish in section 12, a stainless steel finish in section 11, and a natural grained pattern in section 14. In a preferred embodiment, all sections of the article of manufacture would by necessity be of the same tactile type, such as all stone finish or all stainless steel finish, for assembly of an aesthetically consistent, and pleasing, cabinet for a hot tub. Separable section 15 of panel 10 is a structural element being, in this embodiment, a hat section that is used to assemble a cabinet using sections of panels such as those of panel 10.

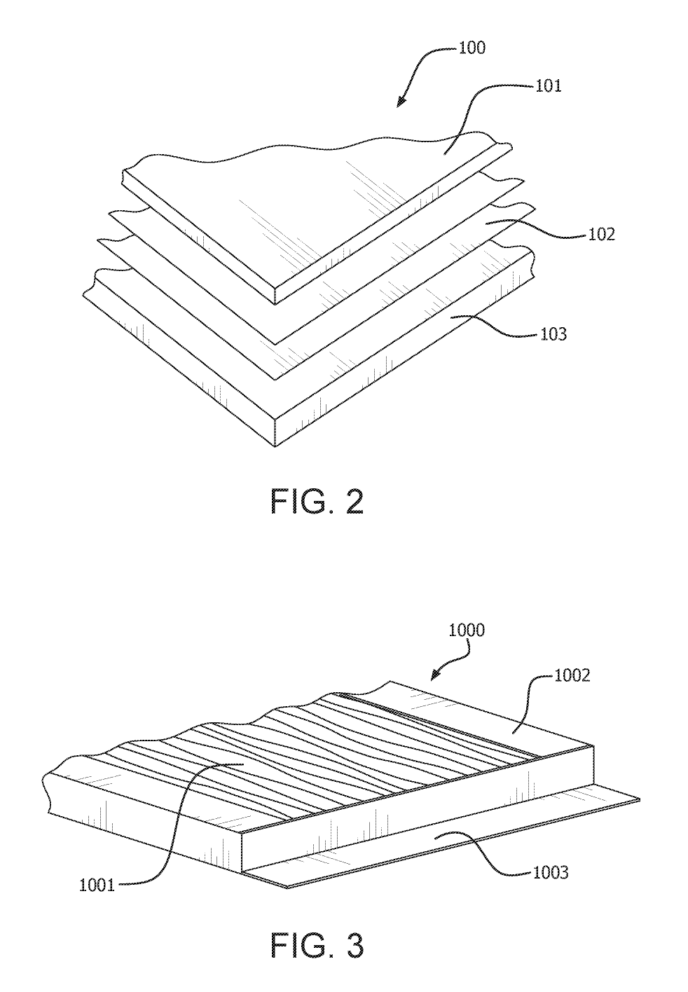

FIG. 2 shows the multi-layer construction of a panel of the present invention, such as panel 100. Top layer 101 is composed of a clear laminate having ultraviolet and abrasion protective properties, such as, without limitation, polyvinyl chloride (PVC), urethane, and acrylic layers. Middle layer 102 is a plastic sheet having digital printing thereon and an adhesive backing. Bottom layer 103 is a substrate composed of a thermoplastic, such as, without limitation, acrylonitrile butadiene styrene (ABS), high impact polystyrene (HIPS), polyethylene terephthalate (PET), and acrylics.

FIG. 3 depicts panel 1000 after being thermoformed. Panel 100 of FIG. 2 is heated and molded against a pattern to produce panel 1000 having the digitally printed pattern shown with relief as on top layer 1001. The top seal 1002 of panel 1000 is formed as a molded structural element as is the mounting flange 1003 as shown in FIG. 3.

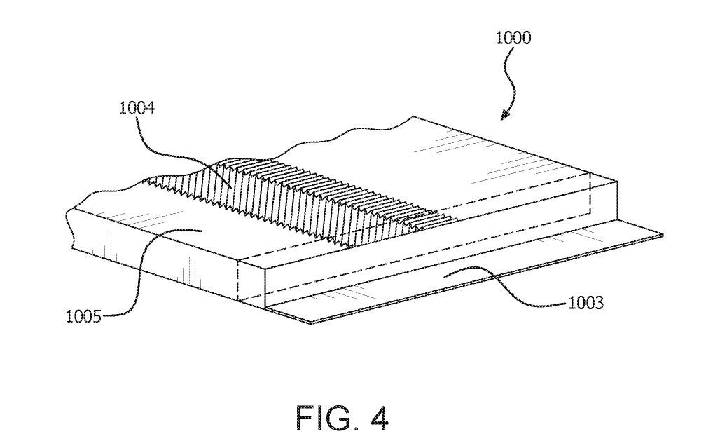

FIG. 4, the perspective view of the cutaway section of panel 1000 shows the full panel assembly interior with its inserted ribs 1004 which are used to stiffen the panel and the interior insulation 1005 used for sound dampening and as a thermal insulation for the hot tub to be enclosed by the cabinet assembled by panels 1000.

As can be appreciated by one skilled in the art, the drawing shown and the manufacture as described herein represent only one embodiment of the invention covered hereby and this application does not limit the breadth of the invention covered hereby to such embodiment or drawing.

What is claimed is:

1. An article of manufacture comprising a plastic panel on which is printed an aesthetic pattern, which pattern has a thermoformed tactile dimension, and onto which are molded at least one plastic structural element to facilitate assembly of a decorative cabinet.

2. The article of manufacture of claim 1 in which said aesthetic pattern is imparted on said panel by digital printing.

3. The article of manufacture of claim 1 in which said aesthetic pattern is selected from the group comprising brushed metal pattern, weathered wood pattern, cobblestone pattern, leather pattern, yarn pattern, fabric pattern, brick pattern, stone pattern, flat finish pattern, and stainless steel pattern.

4. The article of manufacture of claim 1 in which said molded plastic structural element is selected from a group comprising angles, hat sections, clips, and channels.

5. A decorative cabinet for enclosing a hot tub assembled from a panoply of articles of manufacture as described in claim 1 by using such plastic structural elements molded on such articles.

6. A method of production of a decorative cabinet comprised of the steps of: choosing an aesthetic pattern for such decorative cabinet; printing the chosen aesthetic pattern on plastic sheets; thermoforming a tactile dimension on such printed plastic sheets;
molding plastic structural elements onto such thermoformed plastic sheets; and assembling said decorative cabinet from such thermoformed plastic sheets using such molded structural elements.

7. The method of claim 6 in which such printing is digital printing.

8. The method of claim 7 in which said aesthetic pattern is selected from the group comprising brushed metal pattern, weathered wood pattern, cobblestone pattern, leather pattern, yarn pattern, fabric pattern, brick pattern, stone pattern, flat finish pattern, and stainless steel pattern.

9. The method of claim 7 in which said molded plastic structural elements are selected from a group comprising angles, hat sections, clips, and channels.

10. The method of claim 7 in which said decorative cabinet as so assembled encloses a hot tub.
